(19) United States
(12) Patent Application Publication
(10) Pub. No.: US 2017/0012394 A1
(43) Pub. Date: Jan. 12, 2017

(54) FEMALE ELECTRICAL CONNECTOR FOR NON-DIRECTIONAL ELECTRICAL CONNECTOR ASSEMBLY

(71) Applicant: ACES ELECTRONICS CO., LTD., Taoyuan City (TW)

(72) Inventor: Nobukazu KATO, Tokyo (JP)

(21) Appl. No.: 14/794,435

(22) Filed: Jul. 8, 2015

(51) Int. Cl. H01R 13/6581

(52) U.S. Cl. CPC H01R 13/6581

(57) ABSTRACT

A female electrical connector for non-directional electrical connector assembly having the characteristics of ease of fabrication, inexpensiveness and high structural strength is disclosed to include a terminal holder including a holder base and a tongue plate, a set of flat, elongated mating conducting terminals embedded in the terminal holder by insert molding, each flat, elongated mating conducting terminal having a mating conducting portion positioned in the tongue plate with opposing top and bottom contact surfaces thereof respectively exposed to the outside of the opposing top and bottom surfaces of the tongue plate and multiple through hole cut through the mating conducting portion and filled up by the plastic material of the terminal holder, and a shielding housing surrounding the terminal holder and defining therein a mating connection space in which the tongue plate is suspended on the middle.

### BACKGROUND OF THE INVENTION

1. Field of the Invention

The present invention relates to electrical connector technology and more particularly, to a female electrical connector for non-directional electrical connector assembly, which allows insertion of the mating male electrical connector either in an upside-up manner or an upside-down manner to achieve electrical conduction between the female electrical connector and the male electrical connector.

2. Description of the Related Art

Following fast development of computer and electronic technologies, various advanced electronic devices and systems have been well developed and widely used for different applications in the society. Further, it is the market trend to create electronic devices having light, thin, short and small characteristics. In consequence, the dimensions and heights of electrical connectors for these electronic devices must be relatively reduced, complicating the installation of these electrical connectors in respective circuit boards and motherboards and the connection between the electrical connectors and the related electric wires and conducting terminals.

Many electrical connector assemblies may be used in an electronic apparatus to connect different components and parts for signal transmission from one circuit board to a control circuit. An electrical connector assembly generally consists of a male electrical connector and a mating female electrical connector. When connecting the male electrical connector and the mating female electrical connector, the male electrical connector must be inserted in a specific direction to achieve conduction. If you plug the male electrical connector in the wrong direction, conduction between the male electrical connector and the female electrical connector will not be established. In the case that the female electrical connector has a tongue plate, inserting the male electrical connector in the wrong direction can cause impact between the internal structure in the insertion chamber of the male electrical connector and the tongue plate in the mating connection space of the female electrical connector, leading to structural damage or connection failure. Therefore, conventional electrical connector designs have less application flexibility and convenience.

In view of the above-mentioned drawbacks, a female electrical connector with double-sided connection capability was created. According to this design, the tongue plate of the female electrical connector is located on the middle of the connector to divide the mating connection space of the female electrical connector into an upper space area and a lower space area; two sets of mating conducting terminals are respectively mounted in the upper space area and lower space area of the mating connection space. Thus, if the male electrical connector is inserted into the female electrical connector in an upside-up manner, the conducting terminals of the male electrical connector will be forced into the upper space area of the mating connection space to contact the respective mating conducting terminals in the upper space area, achieving electrical conduction. If the male electrical connector is inserted into the female electrical connector in an upside-down manner, the conducting terminals of the male electrical connector will be forced into the lower space area of the mating connection space to contact the respective mating conducting terminals in the lower space area, achieving electrical conduction.

However, in the aforesaid female electrical connector with double-sided connection capability, two sets of mating conducting terminals must be respectively mounted at the opposing top and bottom walls of the tongue plate of the female electrical connector, increasing the fabrication and installation costs of the female electrical connector. Further, the female electrical connector simply allows the connection of one mating male electrical connector at a time, i.e., only the set of mating conducting terminals at the top or bottom wall of the tongue plate can be conducted. Thus, the material cost of this design of female electrical connector with double-sided connection capability is much higher than other conventional designs of female electrical connectors, not cost-effective. An improvement in this regard is desired.

### SUMMARY OF THE INVENTION

The present invention has been accomplished under the circumstances in view. It is therefore the main object of the present invention to provide a female electrical connector for non-directional electrical connector assembly, which has the characteristics of ease of fabrication, inexpensiveness and high structural strength.

To achieve this and other objects of the present invention, a female electrical connector for non-directional electrical connector assembly comprises a terminal holder, a set of flat, elongated mating conducting terminals, and a shielding housing. The terminal holder comprises a holder base and a tongue plate. The flat, elongated mating conducting terminals are embedded in the terminal holder by insert molding, each comprising a mating conducting portion positioned in the tongue plate with opposing top and bottom contact surfaces thereof respectively exposed to the outside of the opposing top and bottom surfaces of the tongue plate and multiple through hole cut through the mating conducting portion and filled up by the plastic material of the terminal holder. The shielding housing surrounds the terminal holder, defining therein a mating connection space in which the tongue plate is suspended on the middle. In application, the mating male electrical connector can be inserted into the female electrical connector either in an upside-up manner or an upside-down manner to achieve electrical conduction between the female electrical connector and the male electrical connector.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a male electrical connector and a female electrical connector of a non-directional electrical connector assembly in accordance with the present invention.

FIG. 2 is an exploded view of the female electrical connector of the non-directional electrical connector assembly in accordance with the present invention.

FIG. 3 is a sectional side view of the female electrical connector of the non-directional electrical connector assembly in accordance with the present invention.

FIG. 4 is a schematic sectional view of the present invention, illustrating the male electrical connector inserted into the mating female electrical connector in an upside-up manner.

FIG. 5 is a schematic sectional view of the present invention, illustrating the male electrical connector inserted into the mating female electrical connector in an upside-down manner.

### DETAILED DESCRIPTION OF THE PREFERRED EMBODIMENT

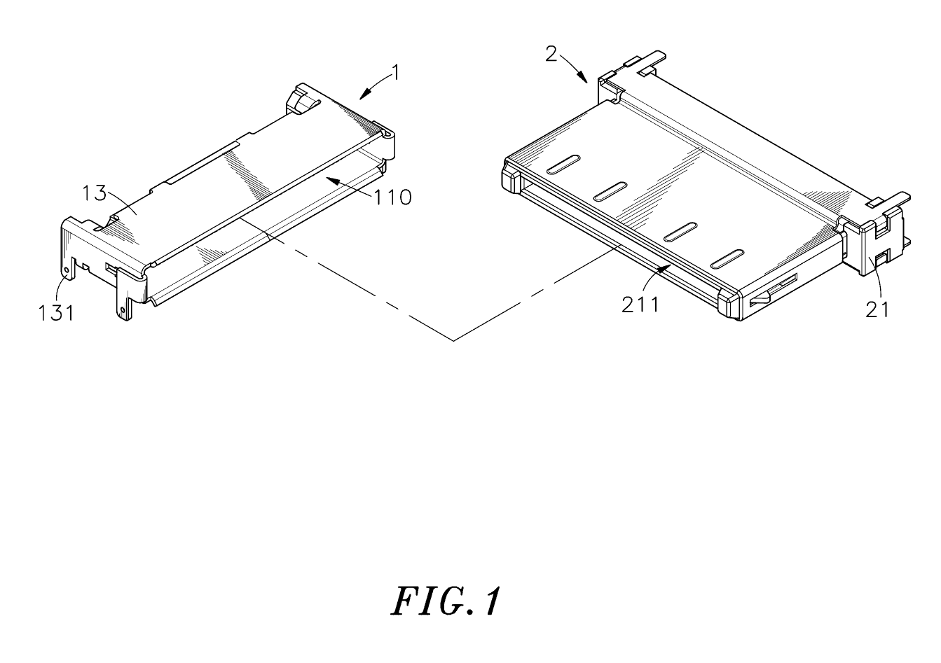

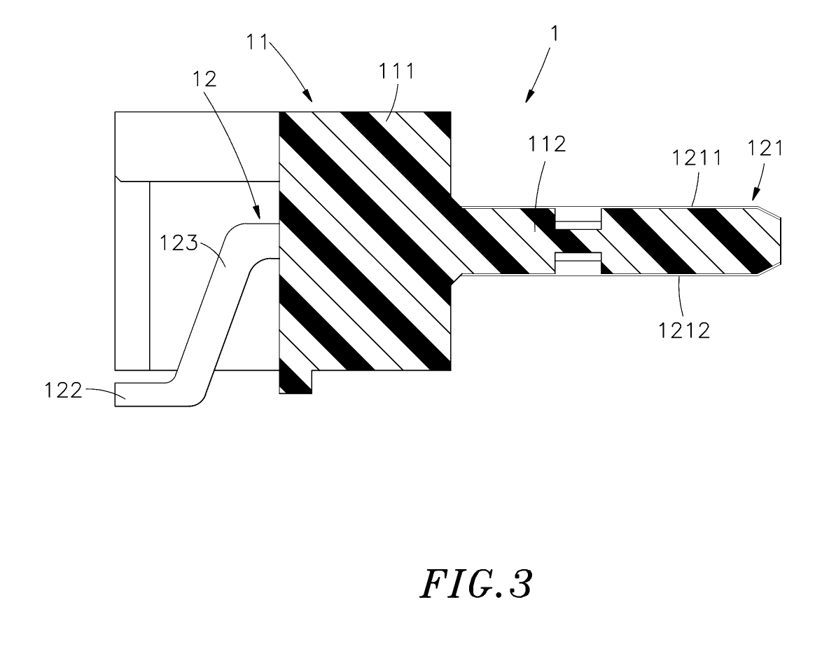

Referring to FIGS. 1, 2 and 3, an exploded view of a male electrical connector and a female electrical connector of a non-directional electrical connector assembly, an exploded view of the female electrical connector of the non-directional electrical connector assembly and a sectional side view of the female electrical connector of the non-directional electrical connector assembly are shown. The non-directional electrical connector assembly comprises a female electrical connector 1 and a male electrical connector 2. The female electrical connector 1 comprises a terminal holder 11, a set of mating conducting terminals 12, and a shielding housing 13. The mating conducting terminals 12 of the female electrical connector 1 are mounted in the terminal holder 11 by insert molding. The terminal holder 11 comprises a holder base 111 and a tongue plate 112 forwardly extended from one side of the holder base 111. The mating conducting terminals 12 each have a respective mating conducting portion 121 positioned in the tongue plate 112. The mating conducting portion 121 of each mating conducting terminal 12 comprises a top contact surface 1211 and an opposing bottom contact surface 1212 respectively exposed to the outside of opposing top and bottom surfaces of the tongue plate 112.

Further, each mating conducting terminal 12 has a plurality of through holes 1210 disposed in the tongue plate 112 that are filled up by the applied molten plastic material during the aforesaid insert molding process. Each mating conducting terminal 12 further comprises a bonding portion 122 exposed to the outside of the holder base 111, and a transition portion 123 obliquely downwardly extended from a rear end of the mating conducting portion 121 remote from the tongue plate 112 and terminating in the bonding portion 122. The shielding housing 13 of the female electrical connector 1 surrounds the terminal holder 11, defining a mating connection space 110 in a front side thereof around the tongue plate 112 for receiving the male electrical connector 2 that can be inserted into the mating connection space 110 in either an upside-up manner or upside-down manner. Further, the shielding housing 13 has a plurality of mounting legs 131 downwardly extended from two opposite lateral sides of a bottom wall thereof.

Further, the mating conducting terminals 12 are flat, elongated metal conducting members made of sheet metal using a stamping technique and respectively positioned in the tongue plate 112 in such a manner that each mating conducting terminal 12 has the width thereof vertically disposed in the tongue plate 112 and the length thereof horizontally disposed in tongue plate 112. Thus, the mating conducting terminals 12 have the advantages of ease of fabrication, inexpensiveness and high structural strength. Further, when molding the terminal holder 11 using an insert molding technique, the applied molten plastic material can fill up the through holes 1210 in the mating conducting portions 121 of the mating conducting terminals 12 to enhance the connection tightness between the tongue plate 112 and the mating conducting portions 121 of the mating conducting terminals 12. Thus, the invention significantly enhances the endurance of the female electrical connector 1 for repetitive plugging into and unplugging out of the male electrical connector 2.

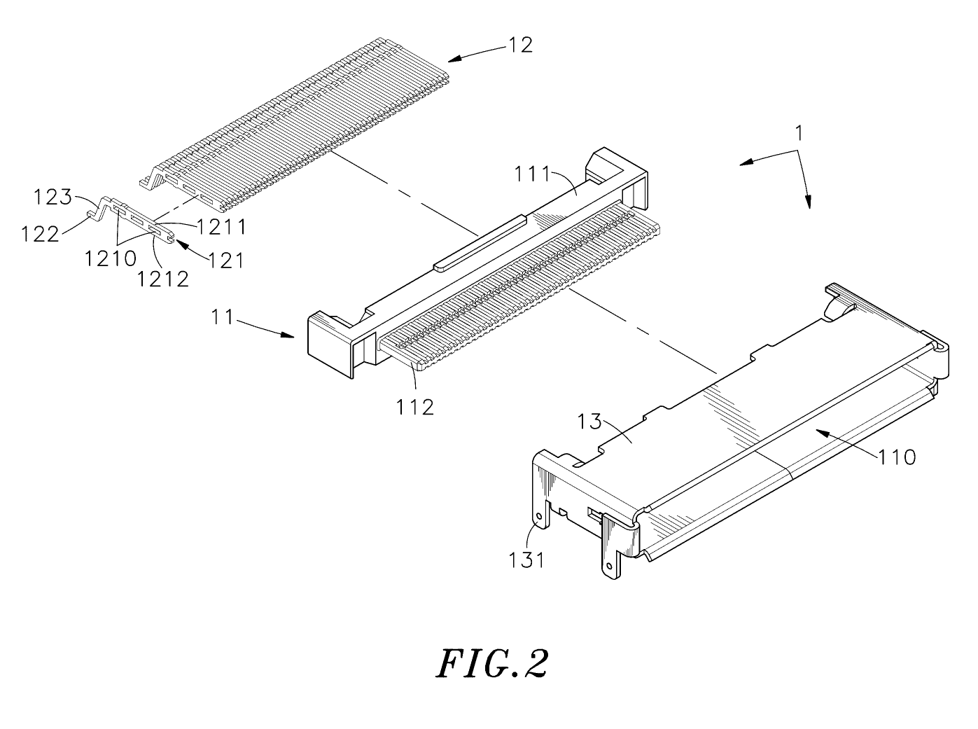

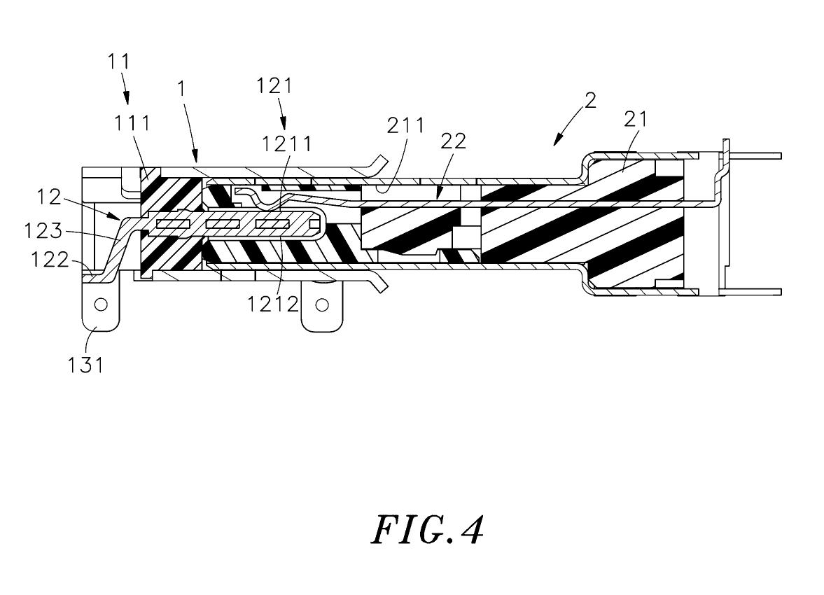

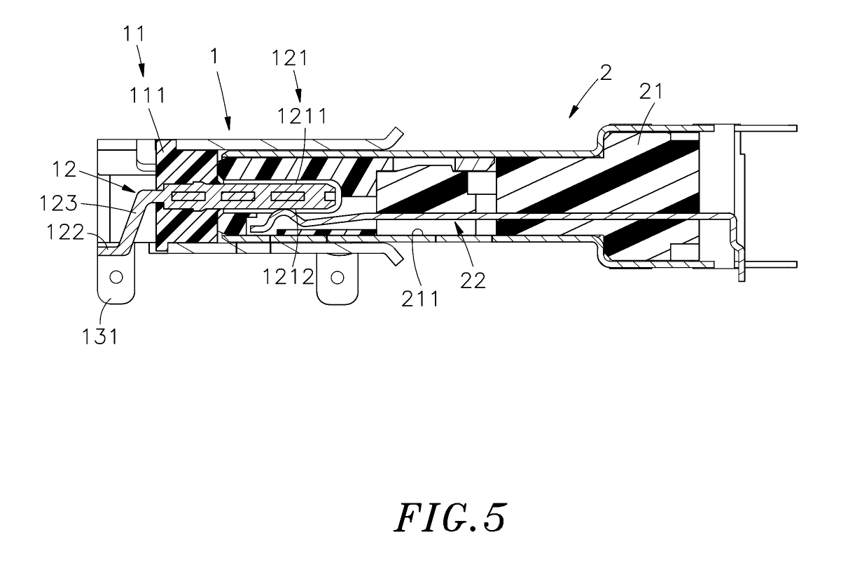

Referring to FIGS. 4 and 5 and FIG. 2 again, after the female electrical connector 1 is assembled, the tongue plate 112 is suspended in the middle of the mating connection space 110 to divide the mating connection space 110 into an upper space area and a lower space area, and the top contact surface 1211 and bottom contact surface 1212 of the mating conducting terminal 12 are respectively exposed to the outside of the opposing top and bottom surfaces of the tongue plate 112. Thus, if the male electrical connector 2 is inserted into the female electrical connector 1 in an upside-up manner to force the tongue plate 112 of the female electrical connector 1 into an insertion chamber 211 of the male electrical connector 2, respective conducting terminals 22 in a terminal holder 21 of the male electrical connector 2 will be forced into the upper space area of the mating connection space 110 in the female electrical connector 1 to electrically contact the respective mating conducting terminals 12 of the female electrical connector 1. On the contrary, if the male electrical connector 2 is inserted into the female electrical connector 1 in an upside-down manner to force the tongue plate 112 of the female electrical connector 1 into the insertion chamber 211 of the male electrical connector 2, respective conducting terminals 22 in the terminal holder 21 of the male electrical connector 2 will be forced into the lower space area of the mating connection space 110 in the female electrical connector 1 to electrically contact the respective mating conducting terminals 12 of the female electrical connector 1. Thus, the male electrical connector 2 can be inserted into the female electrical connector 1 either in an upside-up manner or an upside-down manner to achieve electrical conduction between the female electrical connector 1 and the male electrical connector 2.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A female electrical connector for non-directional female electrical connector assembly for the connection of a male electrical connector, said female electrical connector comprising:
a terminal holder molded from a plastic material, said terminal holder comprising a holder base and a tongue plate forwardly extended from one side of said holder base;
a plurality of mating conducting terminals embedded in said terminal holder by insertion molding, each said mating conducting terminal comprising a mating conducting portion located at one end thereof and positioned in said tongue plate, a plurality of through holes cut through said mating conducting terminal and filled up by the plastic material of said terminal holder and a bonding portion located at an opposite end thereof and exposed to the outside of said terminal holder, said mating conducting portion comprising a top contact surface and an opposing bottom contact surface respectively exposed to the outside of opposing top and bottom surfaces of said tongue plate; and
a shielding housing surrounding said terminal holder and defining therein a mating connection space that accommodates said tongue plate of said terminal holder in such a manner that said tongue plate dividing said mating connection space into an upper space area around the top surface of said tongue plate and an opposing lower space area around the bottom surface of said tongue plate.

2. The female electrical connector for non-directional female electrical connector assembly as claimed in claim 1, wherein each said mating conducting terminal further comprises a transition portion obliquely downwardly extended from a rear end of the respective said mating conducting portion and terminating in the respective said bonding portion.

3. The female electrical connector for non-directional female electrical connector assembly as claimed in claim 1, wherein said shielding housing further comprises a plurality of mounting legs downwardly extended from two opposite lateral sides of a bottom wall thereof.
